(19) United States
(12) Patent Application Publication
(10) Pub. No.: US 2018/0096301 A1
(43) Pub. Date: Apr. 5, 2018

(54) SYSTEMS AND METHODS FOR GENERATING CUSTOMIZED REPORTS BASED ON OPERATIONAL STAGE RULES

(71) Applicant: Mastercard International Incorporated, Purchase, NY (US)

(72) Inventors: Stephen Christopher Kirk, O'Fallon, MO (US); Jeffery T. Sigmon, St. Louis, MO (US)

(21) Appl. No.: 15/282,024

(22) Filed: Sep. 30, 2016

(51) Int. Cl. G06Q 10/10

(52) U.S. Cl. CPC G06Q 10/10

(57) ABSTRACT

A report generating computing device for generating a report based on operational stage rules that are applied sequentially is provided. The computing device includes a processor that is configured to retrieve operational stage data that includes sets of rules defining changes to one or more attributes of a component of the report. The processor is configured to determine a first and a second set of rules associated with corresponding operational stages. The execution of the second set of rules supplement or override the attributes resulting from the first set of rules. The processor is configured to determine a report definition for the component based on the implementation of the sets of rules, to retrieve one or more data records indicated in the determined report definition for the component of the report, and to generate the component of the report based on the report definition and the retrieved database records.

### BACKGROUND

The present application relates generally to generating customized data reports, and more particularly, to systems and methods for reducing the development effort and use of system resources by generating customized data reports based on the operational stage rules.

Many organizations generate data reports to provide a window of information about the organization. For example, a data report may provide financial data, employment data, government data, weather data, educational data, and the like, over a period of time. As one example, a financial company, such as a bank that issues a payment card, may provide monthly reports, quarterly reports, yearly reports, and the like, to their customers as a way of providing their customers with financial information about their account over a period of time. Other entities such as hospitals, schools, government agencies, businesses, and the like, may use reports for many different reasons.

At least some known report generating devices will generate a report based on a format that is hardcoded into the data, the reporting device or on a template file with a single set of rules that define aspects of the report to be generated. In situations in which a first organization has a first set of requirements for a report and a second organization, for example a customer of the first organization, has a second set of requirements for the report, a person must determine how the first requirements interact with the second requirements. Moreover, this specific combination of requirements between the first requirements and the second requirements must be stored as a specific template for that particular customer. If another customer of the first organization has a different set of requirements (e.g., a third set of requirements), a person must determine how the third set of requirements interact with the first set of requirements and store a second template based on the combination of the first and third sets of requirements. As requirements change and as the number of customers increases, the number of templates stored in storage increases, cluttering the storage with different versions of templates for the same combinations of customers. These many stored templates increase the likelihood that an incorrect template might be utilized for a particular combination of organizations. Furthermore, all these stored templates consume valuable memory space and generally reduce the accuracy and efficiency of the computerized generation of data reports.

Accordingly, a system and method for generating a data report without requiring a large amount of system resources (e.g., memory or other storage) is desired. In addition, a system that is capable of more efficiently processing a plurality of data reports simultaneously is desired.

### BRIEF DESCRIPTION OF THE DISCLOSURE

In one aspect, a report generating computing device for generating a report based on operational stage rules that are applied sequentially is provided. The report generating computing device comprises a processor coupled to a memory and to a data source. The processor is configured to retrieve operational stage data from the memory. The operational stage data includes sets of rules defining changes to one or more attributes of at least one component of the report and the sets of rules are stored in association with corresponding operational stage and stakeholder. The processor is further configured to determine, from the retrieved operational stage data, a first set of rules associated with a first operational stage for a stakeholder and to determine, from the retrieved operational stage data, a second set of rules associated with a second operational stage for a stakeholder. The second set of rules supplement or override one or more attributes resulting from execution of the first set of rules. The processor is configured to determine a report definition for the at least one component based on the execution of the first set of rules and the second set of rules. The processor is further configured to retrieve, from the data source, the data definition of one or more data records indicated in the determined report definition for the at least one component of the report and to generate the at least one component of the report based on the report definition and the retrieved data records.

A computer-implemented method for generating a report based on operational stage rules that are applied sequentially is provided. The computer-implemented method is performed by a report generating computing device. The method includes retrieving operational stage data from the memory. The operational stage data includes sets of rules defining changes to one or more attributes of at least one component of the report and the sets of rules are stored in association with corresponding operational stages and stakeholder. The method also includes determining, from the retrieved operational stage data for a stakeholder, a first set of rules associated with a first operational stage and determining, from the retrieved operational stage data a second set of rules associated with a second operational stage for a stakeholder. The second set of rules supplement or override one or more attributes resulting from execution of the first set of rules. The method further includes determining a report definition for the at least one component based on the execution of the first set of rules and the second set of rules. The method also includes retrieving, from the data source, the data definition of one or more data records indicated in the determined report definition for the at least one component of the report and generating the at least one component of the report based on the report definition and the retrieved data records.

In another aspect, computer-readable storage media having computer-executable instructions embodied thereon is provided. When executable instructions are executed by at least one processor associated with a report generating computing device, the computer-executable instructions cause the processor to retrieve operational stage data from the memory. The operational stage data includes sets of rules defining changes to one or more attributes of at least one component of the report and the sets of rules are stored in association with corresponding operational stages for a stakeholder. The computer-executable instructions further cause the processor to determine, from the retrieved operational stage data, a first set of rules associated with a first operational stage for a stakeholder and to determine, from the retrieved operational stage data, a second set of rules associated with a second operational stage for a stakeholder. The second set of rules supplement or override one or more attributes resulting from execution of the first set of rules. The computer-executable instructions also cause the processor to determine a report definition for the at least one component based on the execution of the first set of rules and the second set of rules. The computer-executable instructions further cause the processor to retrieve, from the data source, a data definition of one or more data records indicated in the determined report definition for the at least one component of the report and to generate the at least one component of the report based on the report definition and the retrieved data records.

### BRIEF DESCRIPTION OF THE DRAWINGS

FIG. 1 is a block diagram of an example report generating system including a plurality of computing client devices in accordance with one example embodiment of the present disclosure.

FIG. 2 is a diagram illustrating an example of an operational stage pipeline based report processing flow performed by a report generating computing device in accordance with an example embodiment of the present disclosure.

FIG. 3 is an expanded block diagram of an example embodiment of a server architecture of the report generating analysis system including the plurality of computing devices in accordance with one example embodiment of the present disclosure.

FIG. 4 illustrates an example configuration of a client system shown in FIG. 1.

FIG. 5 illustrates an example configuration of a server system shown in FIG. 1.

FIG. 6 is a flowchart of an example process that may be performed by the report generating system of FIG. 1 for generating customized data reports based on the operational stage rules in accordance with an example embodiment of the present disclosure.

FIG. 7 illustrates a screenshot of an example report definition and corresponding report model generated for an intended issuer bank.

FIG. 8 illustrates a screenshot of an example report definition and corresponding report model generated for an intended customer of an issuer bank.

FIG. 9 illustrates a screenshot of an example report definition and corresponding report model generated for an intended customer of an issuer bank.

### DETAILED DESCRIPTION OF THE DISCLOSURE

According to various aspects described herein, a report generating system may generate customized data reports by implementing a set of operational stage rules that determine the type and the format of specific report data that is to be included in a data report. In particular, the report generating system implements the operational stage rules to create a report definition that defines data records to be included in a data report and the format of the data report. This report generating technique dramatically decreases the amount of storage and memory used by a report generating computing system in comparison to conventional systems. For example, rather than store a customized report definition for each customer, stakeholder, etc. and each “nested” stakeholder, the report generating system described herein creates and stores only a default report definition and the changes necessary to customize the default definition for each customer rather than a customized copy of the definition for each stakeholder. In turn, upon execution, the report generating system utilizes this report definition to determine the appropriate report data to be retrieved from a report data source and the correct formatting of that retrieved report data. In other words, instead of generating and storing a customer-specific report definition for a particular data report, the report generating system stores a default report definition and the stakeholder customizations which uses much less storage space than an entire “hardcoded” customer-specific report definition.

Data reports may be used by many different organizations and entities in order to summarize, visualize, group together, and the like, various pieces of information over a period of time, for example, a day, a week, a month, a quarter, a year, and the like. Examples of organizations that generate data reports include financial entities such as banks, credit card companies, payment processing companies, investment agencies, online trading agencies, and the like. For example, a bank may generate a financial report for their customers on a monthly basis. The financial report may have various presentation characteristics such as wording, placement, graphics, styles, and the like. Moreover, each organization or entity may desire different types of data or different presentations of data depending on the value the presentation provides to different organizations or stakeholders.

For example, a payment processor may choose specific types of data and a specific presentation when generating a set of report data (e.g., transaction data) for an issuer bank. However, the issuer bank may desire to display the type of and presentation of that same set of report data differently to the issuer bank's corporate customer. In implementing this technique, the report generating system utilizes a first operational stage to generate a report that is specifically intended for the issuer bank from the payment processor. The report generating system may add a second operational stage that indicates the addition, modification, or removal of report data (via second operational stage data definitions that may amend or override data definitions in the first operational stage). Another organization, such as the corporate customer, may utilize a third operational stage to further customize this set of report data for another “nested” stakeholder, such as a cardholding employee who works for the corporate customer.

A report generating device according to various aspects includes a processor that may be coupled to a memory and to a data source. The processor may receive or retrieve operational stage data that includes sets of rules defining one or more attributes that correspond to multiple operational stages. The report generating device may determine, from the retrieved operational stage data, a first set of rules associated with a first operational stage and a second set of rules associated with a second operational stage. The report generating device allows for the second set of rules to supplement or override attributes of the report definition resulting from the first set of rules, and a third set of rules (associated with a third operational stage) to supplement or override attributes of the report definition resulting from the first set of rules and the second set of rules. The report generating device may determine a report definition based on the implementation of the first set of rules, the second set of rules, the third set of rules, etc. The report generating device may retrieve, from the data source, one or more data records indicated in the determined report definition for at least one component of the report, and generate the report based on the determined report definition and the retrieved data records. The report may be printed out, downloaded, transmitted, emailed, stored, and the like.

According to various aspects, data reports may be managed utilizing one set of data records and multiple sets of report definitions that define each report for each stakeholder instead of storing multiple copies of the presentation-related data for each report for each stakeholder. Accordingly, the report generating system may store much less report data to generate multiple data reports for multiple stakeholders.

The methods and systems described herein may be implemented using computer programming or engineering techniques including computer software, firmware, hardware or any combination or subset thereof, to perform at least one of the following steps: (a) retrieve operational stage data from the memory, wherein the operational stage data includes sets of rules defining one or more attributes of at least one component of the report and the sets of rules are stored in association with corresponding operational stages; (b) determine, from the retrieved operational stage data, a first set of rules associated with a first operational stage; (c) determine, from the retrieved operational stage data, a second set of rules associated with a second operational stage, wherein the second set of rules supplement or override attributes of the report definition resulting from the first set of rules; (d) determine a report definition for the at least one component based on the implementation of the first set of rules and the second set of rules; (e) retrieve, from the data source, one or more data records indicated in the determined report definition for the at least one component of the report; and (f) generate the at least one component of the report based on the report definition and the retrieved data records.

By performing these steps, the systems are configured to solve a problem in computer memory storage and in generating a report based on operational stages by determining a report definition for a report based on a combination of a first set of rules and a second set of rules that correspond respectively to a first operational stage and a second operational stage and by generating the report based on the report definition and retrieved data records. As described herein, as each new operational stage (and corresponding new set of rules) is added to a report definition, the report generating system determines the interaction between the new set of rules and the set(s) of rules of previously applied operational stages. In determining this interaction of subsequently applied sets of rules, the report generating system may beneficially generate a report using the resulting report definition and data records indicated in the report definition. As such, the system advantageously requires much lower storage requirements in storing a multitude of different customized report definitions for different customers or for a multiple parties of stakeholders (e.g., payment processor, issuer bank, merchant, cardholder, etc.) because a report definition requires a fraction of the storage space that an entire report requires. Moreover, the report generating system is able generate reports dynamically such that any recent or last minute changes or edits made to the report definition will be reflected at the time of report generation, allowing greater flexibility to a customer or stakeholder to customize his or her own report features. Testing time is also reduced generally because only the results of a particular data definition need to be tested rather than each report generated.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

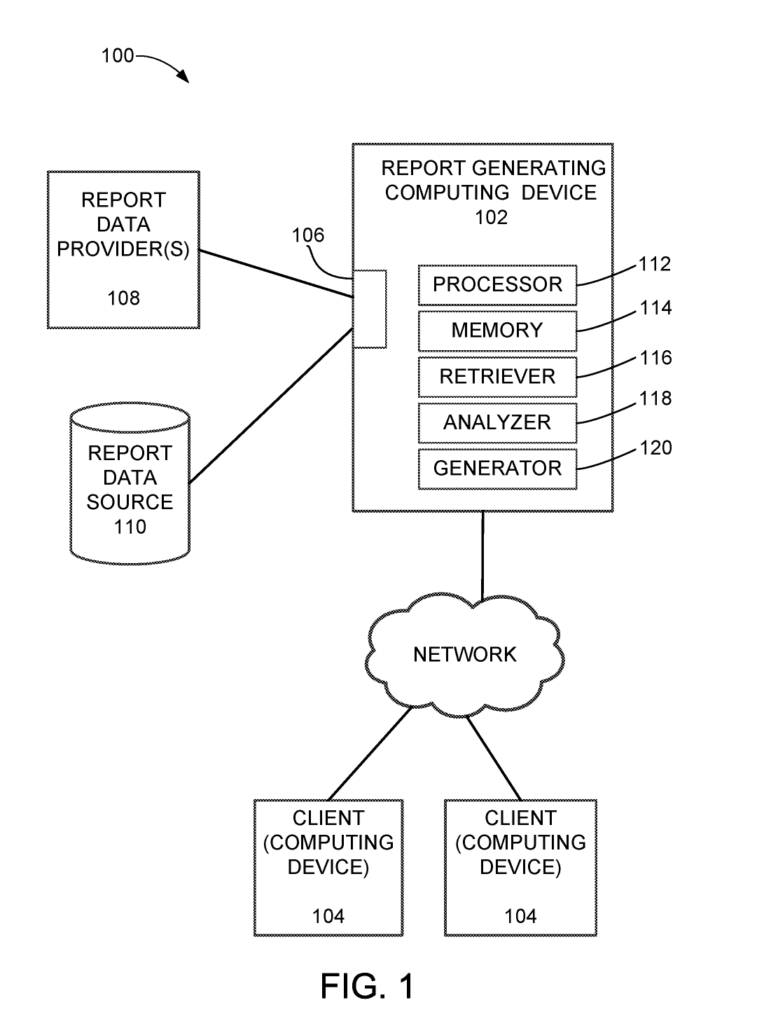

FIG. 1 is a simplified block diagram of an example report generating system 100 in accordance with one embodiment of the present disclosure. In the example embodiment, system 100 includes report generating computing device 102 (e.g., a server) and a plurality of client subsystems, also referred to as client systems 104 or client computing devices, connected to report generating computing device 102. In one embodiment, client systems 104 are computers including a web browser, such that report generating computing device 102 is accessible to client systems 104 using the Internet. Client systems 104 are interconnected to the Internet through many interfaces including a network, such as a local area network (LAN) and/or a wide area network (WAN), dial-in connections, cable modems, wireless-connections, and special high-speed ISDN lines. Client devices 104 may be any device capable of interconnecting to the Internet including a web-based phone, personal digital assistant (PDA), or other web-connectable equipment. A database server 106 is communicatively coupled to a report data source 110 and to one or more report data provider(s) 108 containing report data as described above in greater detail. In one embodiment, report data received or retrieved from report data provider(s) 108 is stored on report generating computing device 102 and may be accessed by potential users at one of client systems 104 by logging onto report generating computing device 102 through one of client systems 104. In any alternative embodiment, report data received or retrieved from report data provider(s) 108 is stored remotely from report generating computing device 102, such as at report data source 110, and may be non-centralized. Report generating computing device 102 may include a processor 112, a memory 114, a retriever 116, an analyzer 118, and a generator 118. Report generating computing device 102 may include additional components not shown, or less than the amount of components shown.

The processor 112 may include one or more processing devices. For example, a processing device may include such as a processor, a controller and an arithmetic logic unit, a digital signal processor, a microcomputer, a field-programmable array, a programmable logic unit, a microprocessor, or any other device capable of running software or executing instructions specifically programmed to perform the steps described herein. The processing device may run an operating system (OS), and may run one or more software applications that operate under the OS. The processor 112 may access, store, manipulate, process, and create data when running software or executing instructions. In the examples herein, the processor 112 may be in communication with or may be coupled to the memory 114. In addition, the processor 112 may control the operations of one or more of the retriever 116, the analyzer 118, the generator 120, and the memory 114.

The retriever 116 may receive input from a user, for example, from an input unit (not shown) that is coupled to report generating computing device 102. As another example, the retriever 116 may receive a user input from another device, for example, through a wired connection, a wireless connection, or a combination thereof. That is, the retriever 116 may receive an instruction from a user of another computing device that is connected to report generating computing device 102 via one or more networks, such as the Internet. In addition, the user of the other computing device may transmit a retrieval request to report generating computing device 102, which may be received by the retriever 116. For example, the memory 114 of report generating computing device 102 may store data reports, and the retrieval request may be a request to download a data report from the memory 114.

Furthermore, the retriever 116 may obtain report data records or report definition data from report data source 110. For example, in response to a command or request to generate a report utilizing a report definition, the retriever 116 may retrieve necessary data records, fields, etc. from the report data source 110 as indicated in the report definition. The analyzer 118 may process and analyze the retrieved the report data. The generator 120 may provide the overall generated report that is based on the report definition to one or more client computing devices 104.

A report definition, a data records, and report may each take many forms, for example, and without limitation, an XML data file, an HTTP request containing report definitions, or any other electronic file that includes a language, technology, etc. agnostic representation of data and/or formatting indicators or instructions that may be used to render or generate a report.

The report data provider 108 may include third party report data that may be publically available or available for purchase. This third party report data may include comparative data that a customer or stakeholder might find helpful in analyzing his or her generated report. For example, in generating a transactional data report for a cardholder of a payment process account, the retriever 116 may obtain transaction or financial data regarding average number or average value of transactions performed by a typical cardholder for a particular jurisdiction, age group, etc. This comparative data of an average cardholder may be included as report data, as indicated in a report definition, in the generated report. As such, the cardholder may compare his or her spending with an average cardholder on the face of the cardholder's generated report.

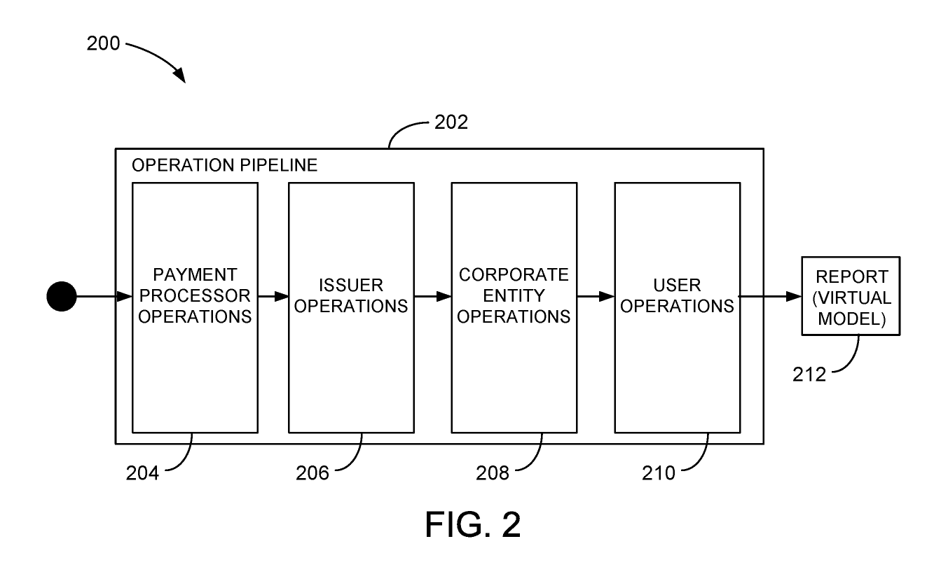

FIG. 2 is a diagram illustrating an example of a report generating flow 200 of report generating computing device 102 in accordance with an example embodiment of the present disclosure. Report generating flow 200 includes a report definition creation flow 202 and a subsequent report (or a virtual model of a report) creation flow 212.

Report definition creation flow 202 includes multiple operational stages that are configured in a pipeline manner (i.e., the output of a first stage is the input of a second stage and so forth). Each operational stage includes a specific set of rules that may be defined by a particular entity, organization, process, etc. For example, the specific set of rules for any operational stage may pertain to an output field, a sorting field, a grouping field, filter criteria, a field calculated from values within the data record, a field calculated from values within the data record grouping, a field calculated from the values across the entire data set, a styling component, a branding component, any visual component within the report header, a visual component within the report footer, an output file format, a data window, a user-defined data calculation, a date/time localization, a numeric localization, a currency conversion, or any other suitable attribute. While any number of operational stages may be utilized, the four operational stages shown in FIG. 2 are not intended to be a limiting feature of the report generating system 100. In the example shown in FIG. 2, an operational stage pipeline may be created for a payment processor and its stakeholders, which include an issuer bank, a corporate entity, and a user or cardholder. A report definition may be realized by implementing these four operational stages such that each operational stage may be intended for or managed by a different organizational entity.

An operational stage may include data-related definitions or indicators and, additionally or alternatively, may include data presentation-related definitions or indicators. Moreover, the rules or definitions of each downstream operational stage may override or supplement the rules or definitions of any upstream operational stage. For example, as shown in FIG. 2, a first operational stage may be include payment processor operations 204 that are intended for (and/or managed by) a payment processor. The payment processor may log into report generating computing device 102 from one of client computing devices 104 to create, modify, or delete rules affecting the report definition (i.e., a set of rules pertaining specifically to the payment processor operations 204 operational stage).

Likewise, the issuer bank, corporate entity, or user/cardholder may additionally transmit, to report generating computing device 102, a request to create, modify, or delete rules affecting the report definition corresponding to its operational stage via one of client computing devices 104. The issuer bank may manage the data definitions or rules for its issuer operations 206 operational stage, the corporate entity may manage the data definitions or rules for its corporate entity operations 208 operational stage, and the user may manage the data definitions or rules for his or her user operations 210 operational stage. Each downstream operational stage may add, modify, remove, etc. different data fields or data records from upstream operational stages and may affect presentation of certain data.

At the time the report definition is executed by report generating system 100 to generate a report or report virtual model file 212, the resulting report is tailored to the needs of that specific entity. A virtual model file 212 may be generated at the time of execution (i.e., prior to the report generation) or may be stored in report data source 110. Furthermore, the virtual model file 212 may be generated from stored rules or data definitions. For example, at the request of the issuer bank, a payment processor may customize a first operational stage to be tailored to the needs of the issuer bank such that issuer bank desired specific data fields are included and presented in a specific manner. Moreover, continuing this example, the payment processor may include the payment processor's logo or branding, etc.

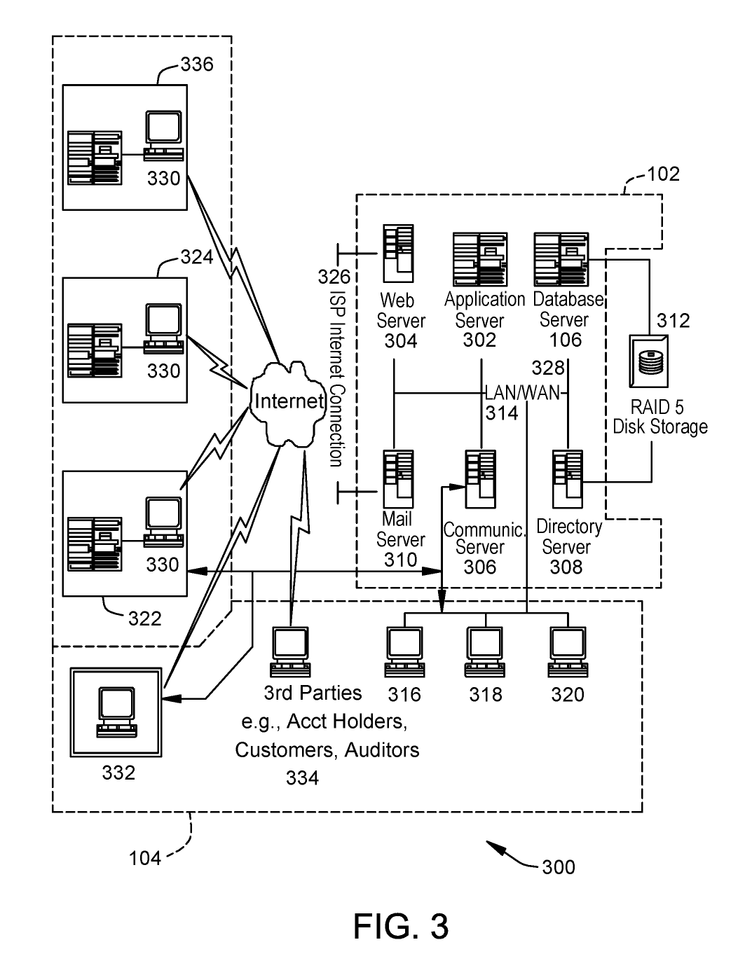

FIG. 3 is an expanded block diagram of an example embodiment of a server architecture of a report generating system 300 in accordance with one embodiment of the present disclosure. Report generating system 300 includes report generating computing device 102 and client systems 104. Report generating computing device 102 further includes database server 106, an application server 302, a web server 304, a communication server 306, a directory server 308, and a mail server 310. A disk storage unit 312 is coupled to database server 106 and directory server 308. Servers 106, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet. For example, one of the workstations 320 may include the payment processor 336 and respective payment processing database.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Report generating computing device 102 is configured to be communicatively coupled to various entities, for example, including acquirers 322 and issuers 324, and to third parties, e.g., auditors 334, using an Internet connection 326. Report generating computing device 102 may also communicatively coupled with a payment processor 336 to obtain transaction data, for example. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, LAN 314 could be used in place of WAN 328.

In the example embodiment, any authorized individual or entity having a workstation 330 may access system 300. At least one of the client systems includes a manager workstation 332 located at a remote location. Workstations 330 and 332 include personal computers having a web browser. Also, workstations 330 and 332 are configured to communicate with report generating computing device 102. Furthermore, communication server 306 communicates with remotely located client systems, including a client system 332, using a telephone link. Communication server 306 is configured to communicate with other client systems 316, 318, and 320 as well.

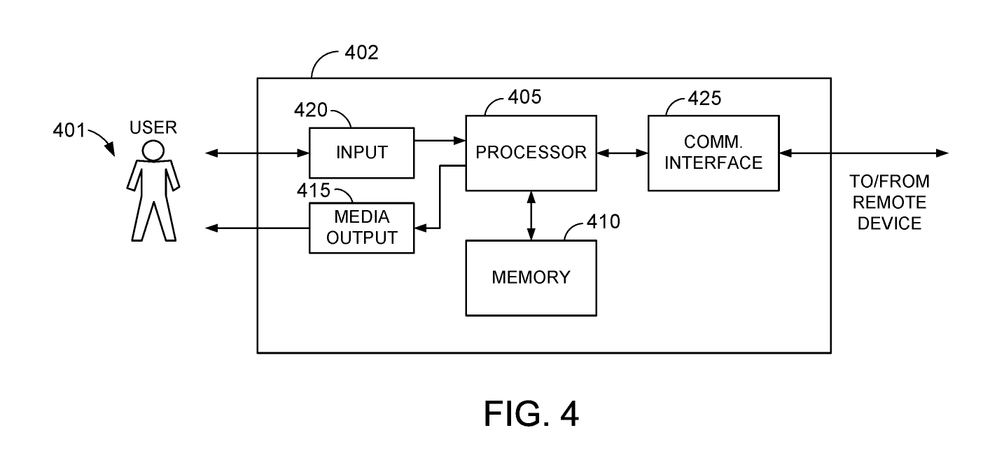

FIG. 4 illustrates an example configuration of a requester computing device 402 operated by a requestor 401 (i.e., user) who may desire to transmit a request to report generating computing device 102. Requester computing device 402 may include, but is not limited to, client systems (“client computing devices”) 104, 316, 318, and 320, workstation 330, and manager workstation 332 (shown in FIG. 3).

Requester computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

Requester computing device 402 also includes at least one media output component 415 for presenting information to user 401. Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, requester computing device 402 includes an input device 420 for receiving input from user 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

Requester computing device 402 may also include a communication interface 425, which is communicatively couplable to a remote device such as report generating computing device 102 or a web server. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface to user 401 via media output component 415 and, optionally, receiving and processing input from input device 420. A user interface may include, among other possibilities, a web browser and client application. Web browsers enable users 401 to display and interact with media and other information typically embedded on a web page or a website from report generating computing device 102 or a web server. A client application allows user 401 to interact with a server application from report generating computing device 102 or a web server.

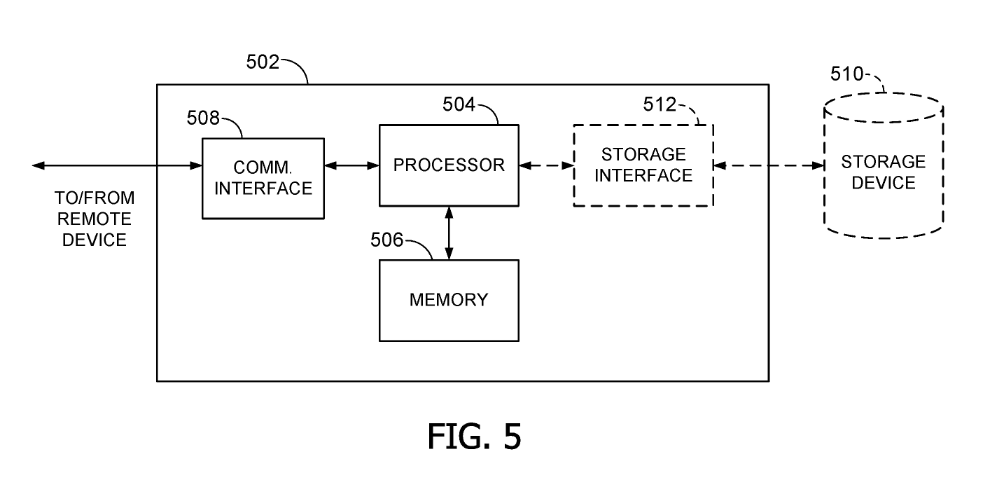

FIG. 5 illustrates an example configuration of a report generating computing device 502 such as report generating computing device 102 (shown in FIGS. 1 and 3). Report generating computing device 502 may include, but is not limited to, database server 106, application server 302, web server 304, communication server 306, directory server 308, and mail server 310.

Report generating computing device 502 includes a processor 504 for executing instructions. Instructions may be stored in a memory area 506, for example. Processor 504 may include one or more processing units (e.g., in a multi-core configuration).

Processor 504 is operatively coupled to a communication interface 508 such that report generating computing device 502 is capable of communicating with a remote device such as requester computing device 402 or another report generating computing device 502. For example, communication interface 508 may receive requests from client systems 104 via the Internet, as illustrated in FIGS. 1 and 3.

Processor 504 may also be operatively coupled to a storage device 510. Storage device 510 is any computer-operated hardware suitable for storing and/or retrieving data. In some embodiments, storage device 510 is integrated in report generating computing device 502. For example, report generating computing device 502 may include one or more hard disk drives as storage device 510. In other embodiments, storage device 510 is external to server computing device 502 and may be accessed by a plurality of report generating computing devices 502. For example, storage device 510 may include multiple storage units such as hard disks or solid-state disks in a redundant array of inexpensive disks (RAID) configuration. Storage device 510 may include a storage area network (SAN) and/or a network attached storage (NAS) system.

In some embodiments, processor 504 is operatively coupled to storage device 510 via a storage interface 512. Storage interface 512 is any component capable of providing processor 504 with access to storage device 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 504 with access to storage device 510.

Memory 506 may include and/or be substantially similar to memory 114 (shown in FIG. 1). Memory 506 may store data, for example, data related to report generating and/or other data. Memory 506 may include one or more of a random access memory (RAM) such as dynamic RAM (DRAM) or static RAM (SRAM), a read-only memory (ROM), an erasable programmable read-only memory (EPROM), an electrically erasable programmable read-only memory (EEPROM), a non-volatile RAM (NVRAM), and the like. The memory types are exemplary only, and are thus not limiting as to the types of memory usable for memory 506 of report generating computing device 502.

Memory areas 410 and 506 may store data, for example, data related to report generating and/or other data. Moreover, memory areas 410 and 506 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

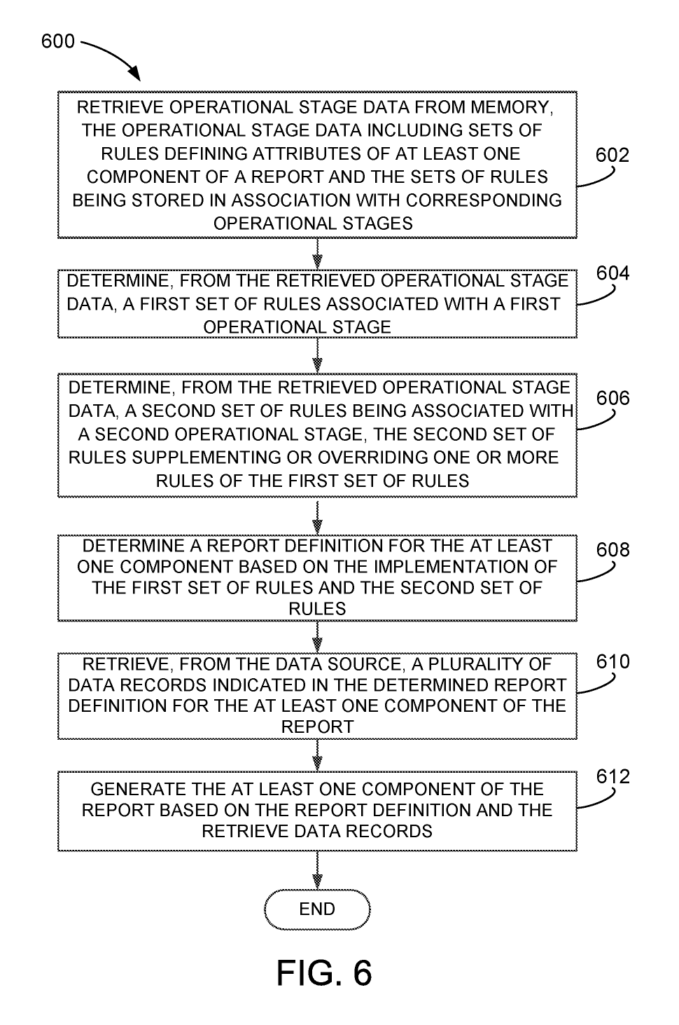

Referring to FIG. 6, an example of a method 600 for generating a data report from a report definition that includes operational stages in accordance with an example embodiment of the present disclosure is shown. The method 600 may be performed by a report generating computing device (e.g., report generating computing device 102, shown in FIG. 1). The method 600 includes retrieving (602), from memory (or from storage), operational stage data that includes sets of rules defining one or more attributes for one or more components of the report in addition to default attributes for the default report definition on which the set of rules are executed upon. The set of rules are stored in association with the corresponding operational stage. The method 600 includes determining (604) a first set of rules associated with a first operational stage and determining (606) a second set of rules associated with a second operational stage. For example, the specific set of rules for any operational stage may pertain to an output field, a sorting field, a grouping field, filter criteria, a field calculated from values within the data record, a field calculated from values within the data record grouping, a field calculated from the values across the entire data set, a styling component, a branding component, any visual component within the report header, a visual component within the report footer, an output file format, a data window, a user-defined data calculation, a date/time localization, a numeric localization, a currency conversion, or any other suitable attribute.

Importantly, the method 600 allows for the second set of rules to supplement, override, modify, etc. one or more attributes resulting from execution of the first set of rules. These rules may affect data definitions, data fields, etc. as reflected in the output report definition of that particular operational stage.

The method 600 further may determine (608) a report definition for one or more components of the report based on implementation, application, combination, etc. of the first set of rules and the second set of rules. At run time or at execution of the report generation, the report generating device may determine instances of when the execution of a rule, data definition, etc. of the second set of rules creates one or more attributes that override or supplement the one or more attributes already present in the report definition and previously generated by the one or more rules of the first set of rules. In this way, a particular rule of the second set of rules generates an attribute that takes precedent over the one or more attributes generated by the first set of rules. This technique additionally extrapolates such that a rule of a third set of rules may generate one or more attributes that override, supplement, or otherwise change an attribute updated not only by the second set of rules but also the first set of rules.

In any event, the method 600 may further retrieve (610) one or more data records from a data source as indicated in the determined report definition. The method 600 may generate (612) one or more components of the report based on the retrieved data records and the report definition.

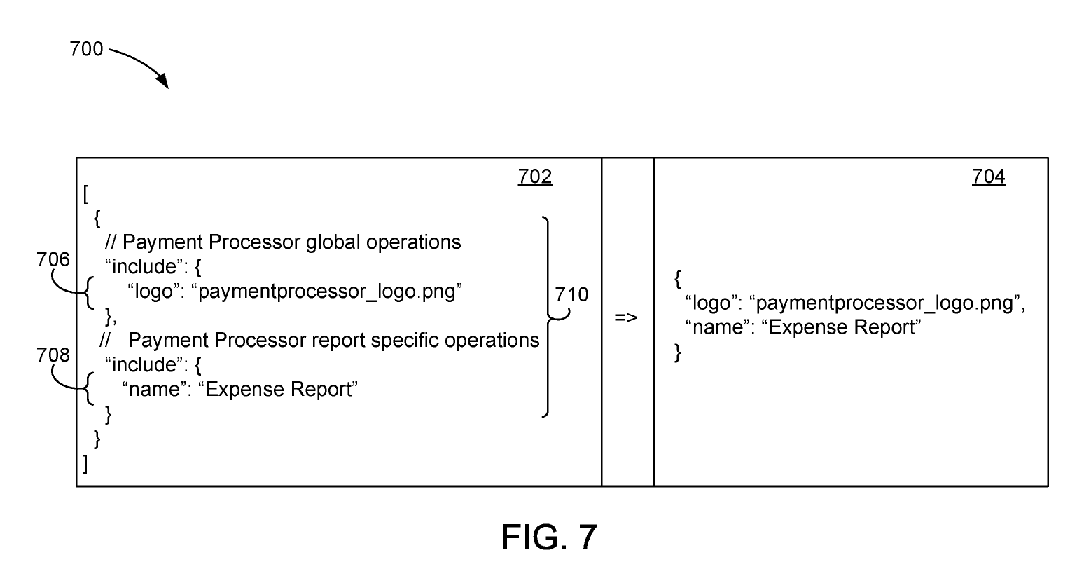

FIG. 7 illustrates a screenshot 700 of an example report definition rule set 702 and example resulting report definition (or virtual model file) 704 that includes a first operational stage of payment processor operations 710. The report definition rule set 702 is associated with the first operational stage 710 that includes a payment processor organization-specific operations portion and a payment processor report specific operations portion. The organization-specific operations generally apply each time the report definition rule set 702 is executed and may operate on every report generated. On the other hand, the report specific operations may only perform operations on a specific report, as opposed to every report. At the time of execution, the resulting report definition 704 is generated from a default report definition (not specifically shown) and application of the rule set 702 that may be used to create the report, which includes the expense report transactions and related transaction data that may be retrieved from report data source 110 as defined by one or more data definitions (not shown) in the final report definition 704. Furthermore, the resulting report generated from the report definition 704 also includes the presentation-related data that includes payment processor's logo (e.g., the image file “paymentprocessor_logo.png”) and the heading or name “Expense Report” as defined by the respective data definitions 706, 708 of report definition rule set 702. Any number of components of the report may be generated at the time of execution.

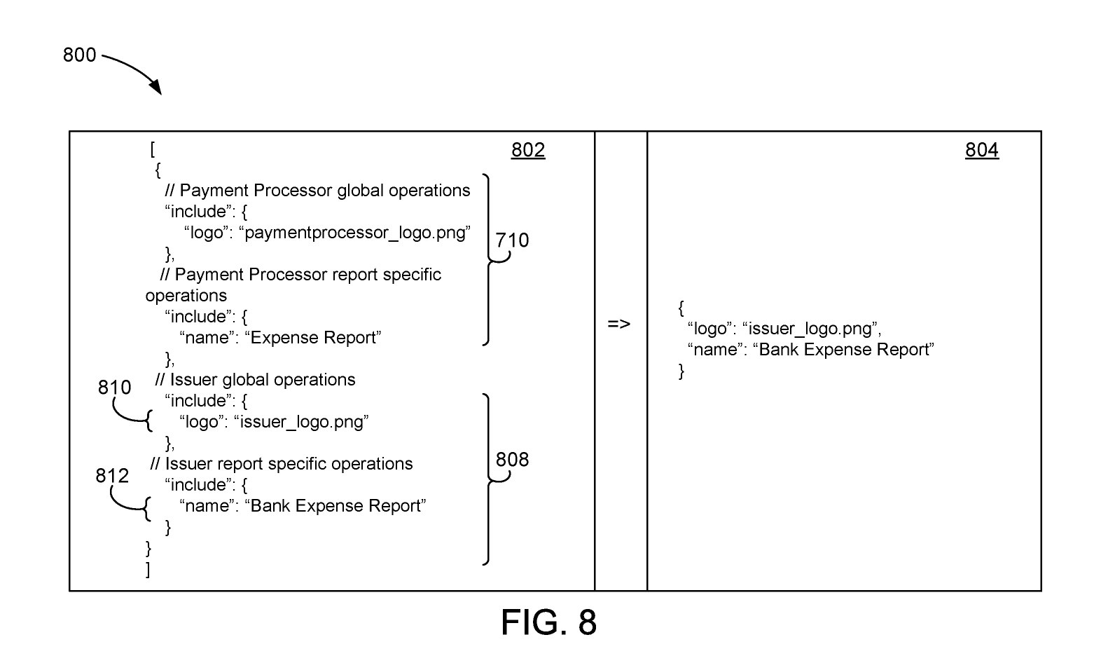

FIG. 8 illustrates a screenshot 800 of an example report definition rule set collection 802 (also referred to herein as “report definition rule sets” 802) and example resulting report definition (or virtual model file) 804 that includes a first operational stage of payment processor operations 710 and a second operational stage of issuer operations 808. The payment processor organization-specific operations portion and the payment processor specific operations portion are identical to the two payment processor portions in FIG. 7. However, the second operational stage 808 of the report definition rule sets 802 of FIG. 8 includes an issuer organization-specific operations portion and an issuer report specific operation portion that operate similarly to the two payment processor portions of the first operational stage 710. In any event, at the time of execution of the report definition rule sets 802, the operations of the second operational stage 808 may override or supplement the operations (i.e., rules, data definitions 706, 708, etc.) of the first operational stage 710. For example, the issuer organization-specific operation portion includes the issuer's logo (e.g., “issuer_logo.png” in a data definition 810) that will override the data definition 706 of the payment processor's logo. Moreover, the issuer specific operation portion includes a data definition 812 that further defines or supplements the heading or name of the expense report “Bank Expense Report”, as opposed to the data definition “Expense Report” 708 in the first operational stage 710.

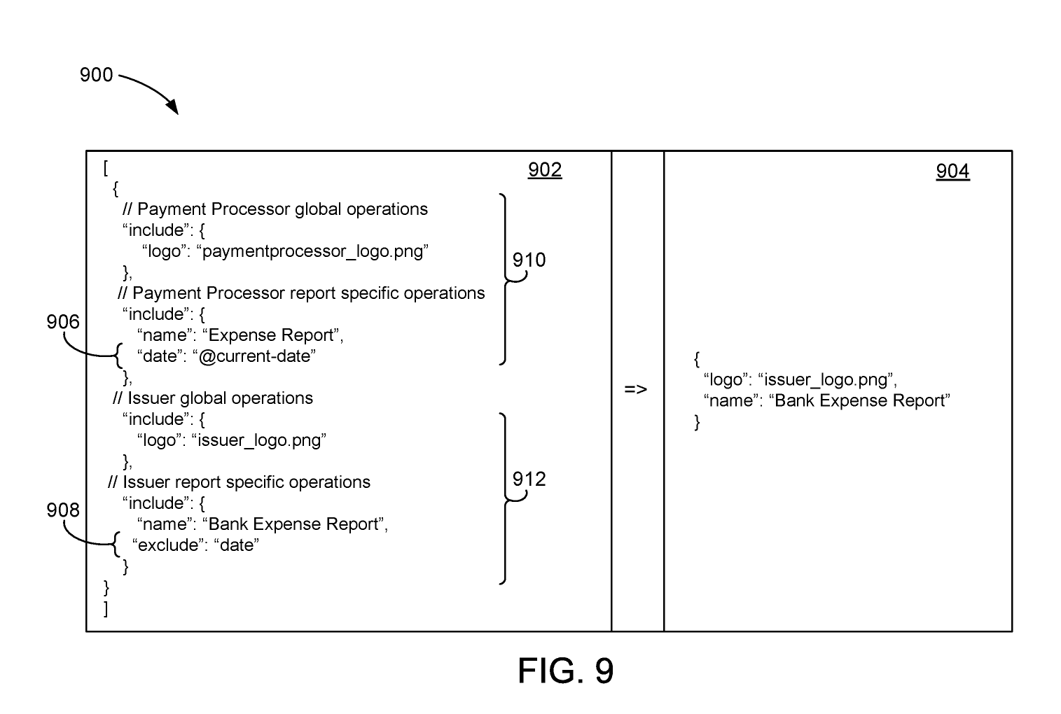

FIG. 9 illustrates a screenshot 900 of an example report definition rule set collection 902 (also referred to as “report definition rule sets” 902) and example resulting report definition (or virtual model file) 904 that includes a first operational stage of payment processor operations 910 and a second operational stage of issuer operations 912. The payment processor organization-specific operational stage 910 in FIG. 9 has been amended from the operational stage 710 in FIGS. 7 and 8 to include a date data definition 906 for the expense report. Moreover, the second operational stage 912 of the report definition rule sets 902 of FIG. 9 includes an issuer report specific operation portion that includes a date exclusion data definition 908. As a result, at execution (i.e., generation of the expense report), the presentation of a date will not be displayed due to the date exclusion data definition 908 in the second operational stage 912 taking precedence over the date data definition 906 in the first operational stage 910.

In some aspects, the method may include receiving a report model including at least one of a font, a style, and a field ordering of the data report. Here, the changes may include inserting the identified data field into the data report based on the report model.

The computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

For example, one or more computer-readable storage media may include computer-executable instructions embodied thereon for generating a data report from a report definition. In this example, the computing device may include a memory device and a processor in communication with the memory device, and when executed by the processor the computer-executable instructions may cause the processor to perform a method such as the method described and illustrated in the example of FIG. 6.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example, the system is executed on a single computer system, without a connection to a server computer. In a further example, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A report generating computing device for generating a report based on operational stage rules that are applied sequentially, the report generating computing device comprises a processor coupled to a memory and to a data source, the processor is configured to:
retrieve operational stage data from the memory, wherein the operational stage data includes sets of rules defining changes to one or more attributes of at least one component of the report and the sets of rules are stored in association with corresponding operational stages;
determine, from the retrieved operational stage data, a first set of rules associated with a first operational stage;
determine, from the retrieved operational stage data, a second set of rules associated with a second operational stage, wherein the second set of rules supplement or override one or more attributes resulting from execution of the first set of rules;
determine a report definition for the at least one component based on the execution of the first set of rules and the second set of rules;
retrieve, from the data source, one or more data records indicated in the determined report definition for the at least one component of the report; and
generate the at least one component of the report based on the report definition and the retrieved data records.

2. The report generating computing device of claim 1, the processor further configured to:
receive, from a client device, a user-initiated rule modification request that includes the selection of one of the operational stages that a user desires to modify;
receive, from the client device, one or more user-initiated rules for modifying the set of rules associated with the selected one of the operational stages; and
store the one or more user-initiated rules in association with the selected operational stage in the operational stage data.

3. The report generating computing device of claim 2, the processor further configured to receive the one or more user-initiated rules through a web-based user interface.

4. The report generating computing device of claim 1, the processor further configured to store the resulting report definition as a virtual model file in the memory for later retrieval.

5. The report generating computing device of claim 1, the processor further configured to execute the first set of rules and the second set of rules in response to receiving a command to generate the report.

6. The report generating computing device of claim 1, the processor further configured to execute the first set of rules and the second set of rules pertaining to at least one of an output field, a sorting field, a grouping field, filter criteria, a field calculated from values within the data record, a field calculated from values within the data record grouping, a field calculated from the values across the entire data set, a styling component, a branding component, any visual component within the report header, any visual component within the report footer, an output file format, a data window, a user-defined data calculation, a date/time localization, numeric localization, and a currency conversion.

7. The report generating computing device of claim 1, the processor further configured to generate the report using a combination of operational stages that apply to organization-specific settings and to report-specific settings.

8. The report generating computing device of claim 1, the processor further configured to generate the report using more than two operational stages.

9. A computer-implemented method for generating a report based on operational stage rules that are applied sequentially, the computer-implemented method being performed by a report generating computing device, the computer-implemented method comprising:
retrieving operational stage data from the memory, wherein the operational stage data includes sets of rules defining changes to one or more attributes of at least one component of the report and the sets of rules are stored in association with corresponding operational stages;
determining, from the retrieved operational stage data, a first set of rules associated with a first operational stage;
determining, from the retrieved operational stage data, a second set of rules associated with a second operational stage, wherein the second set of rules supplement or override one or more attributes resulting from the first set of rules;
determining a report definition for the at least one component based on the execution of the first set of rules and the second set of rules;
retrieving, from the data source, one or more data records indicated in the determined report definition for the at least one component of the report; and
generating the at least one component of the report based on the report definition and the retrieved data records.

10. The computer-implemented method of claim 9, further comprising:
receive, from a client device, a user-initiated rule modification request that includes the selection of one of the operational stages that a user desires to modify;
receive, from the client device, one or more user-initiated rules for modifying the set of rules associated with the selected one of the operational stages; and
store the one or more user-initiated rules in association with the selected operational stage in the operational stage data.

11. The computer-implemented method of claim 10, further comprising receiving the one or more user-initiated rules through a web-based user interface.

12. The computer-implemented method of claim 9, further comprising storing the resulting report definition as a virtual model file in the memory for later retrieval.

13. The computer-implemented method of claim 9, further comprising executing the first set of rules and the second set of rules in response to receiving a command to generate the report.

14. The computer-implemented method of claim 9, further comprising executing the first set of rules and the second set of rules pertaining to at least one of an output field, a sorting field, a grouping field, filter criteria, a field calculated from values within the data record, a field calculated from values within the data record grouping, a field calculated from values across the entire data set, a styling component, a branding component, any visual component within the report header, any visual component within the report footer, an output file format, a data window, a user-defined data calculation, a date/time localization, a numeric localization, and a currency conversion.

15. The computer-implemented method of claim 9, further comprising generating the report using a combination of operational stages that apply to organization-specific settings and to report-specific settings.

16. The computer-implemented method of claim 9, further comprising generating the report using more than two operational stages.

17. Computer-readable storage media having computer-executable instructions embodied thereon, wherein, when executed by at least one processor associated with a report generating computing device, the computer-executable instructions cause the processor to:
retrieve operational stage data from the memory, wherein the operational stage data includes sets of rules defining changes to one or more attributes of at least one component of the report and the sets of rules are stored in association with corresponding operational stages;
determine, from the retrieved operational stage data, a first set of rules associated with a first operational stage;
determine, from the retrieved operational stage data, a second set of rules associated with a second operational stage, wherein the second set of rules supplement or override one or more attributes resulting from the first set of rules;
determine a report definition for the at least one component based on the execution of the first set of rules and the second set of rules;
retrieve, from the data source, one or more data records indicated in the determined report definition for the at least one component of the report; and
generate the at least one component of the report based on the report definition and the retrieved data records.

18. The computer-readable storage media in accordance with claim 17, the executable instructions further cause the processor to:
receive, from a client device, a user-initiated rule modification request that includes the selection of one of the operational stages that a user desires to modify;
receive, from the client device, one or more user-initiated rules for modifying the set of rules associated with the selected one of the operational stages; and
store the one or more user-initiated rules in association with the selected operational stage in the operational stage data.

19. The computer-readable storage media in accordance with claim 17, the executable instructions further cause the processor to receive the one or more user-initiated rules through a web-based user interface.

20. The computer-readable storage media in accordance with claim 17, the executable instructions further cause the processor to implement the first set of rules and the second set of rules in response to receiving a command to generate the report.
